(19) United States
(12) Patent Application Publication
(10) Pub. No.: US 2026/0054367 A1
(43) Pub. Date: Feb. 26, 2026

(54) ADAPTER AND POWER TOOL

(71) Applicant: Nanjing Chervon Industry Co., Ltd., Nanjing (CN)

(72) Inventors: Dong Yang, Nanjing (CN); Shuang Li, Nanjing (CN); Yinghao Zhang, Nanjing (CN)

(21) Appl. No.: 19/376,003

(22) Filed: Oct. 31, 2025

Related U.S. Application Data
(63) Continuation of application No. PCT/CN2024/096384, filed on May 30, 2024.

(30) Foreign Application Priority Data
Jun. 20, 2023 (CN) 202310736616.4

(51) Int. Cl. B25F 5/02; H02J 7/00

(52) U.S. Cl. CPC B25F 5/02; H02J 7/00036; H02J 7/00038

(57) ABSTRACT

An adapter includes: a power input terminal for connecting an AC power supply; a power circuit that performs energy conversion on the inputted AC power to obtain electrical energy capable of powering a power tool; and a tool interface connected to a power interface of the power tool to output electrical energy. The adapter further includes a data transmission module connected to at least the tool interface and capable of outputting first communication data and/or first internal resistance data to the tool interface so that the power tool is capable of identifying the adapter according to the first communication data and/or the first internal resistance data. The first communication data includes at least adapter identification data, and the adapter identification data enables the power tool to identify that a connected device is the adapter between the adapter and a battery pack.

This application is a continuation of International Application Number PCT/CN2024/096384, filed on May 30, 2024, through which this application also claims the benefit under 35 U.S.C. § 119(a) of Chinese Patent Application No. CN 202310736616.4, filed on Jun. 20, 2023, which applications are incorporated herein by reference in their entireties.

### BACKGROUND

In the related art, a direct current (DC) power tool can not only be powered by a battery pack but also be connected to an alternating current (AC) adapter to obtain electrical energy. It may also be understood as that the battery pack and the AC adapter can be used as power supply devices for the DC power tool. Due to the different characteristics of the battery pack and the adapter, the supported working performance of the power tool powered by the battery pack is different from the supported working performance of the power tool powered by the adapter. Therefore, the power tool needs to be capable of identifying the type of the power supply device connected to the power tool. This part provides background information related to the present application, and the background information is not necessarily the existing art.

### SUMMARY

The present application adopts the technical solutions below.

An adapter includes: a power input terminal for connecting an AC power supply; a power circuit configured to perform energy conversion on the inputted AC power to obtain electrical energy capable of powering a power tool; and a tool interface configured to be connected to a power interface of the power tool to output electrical energy. The adapter further includes a data transmission module connected to at least the tool interface and capable of outputting first communication data and/or first internal resistance data to the tool interface so that the power tool is capable of identifying the adapter according to the first communication data and/or the first internal resistance data. The first communication data includes at least adapter identification data, and the adapter identification data is configured to enable the power tool to identify that a connected device is the adapter between the adapter and a battery pack.

In some examples, the data transmission module includes a first communication module, and a communication protocol supported by the first communication module is at least the same as a communication protocol supported by the battery pack.

In some examples, a first communication module is configured to transmit the first communication data and/or the first internal resistance data in a wired communication manner and/or a wireless communication manner.

In some examples, the first communication data includes an identification frame and a communication frame, where the adapter identification data is provided in the identification frame and/or the communication frame.

In some examples, the data transmission module includes an adapter internal resistance processing module capable of at least detecting and transmitting the first internal resistance data.

In some examples, the data transmission module is configured to output the first communication data and then transmit the first internal resistance data after a preset period so that the power tool is capable of identifying the adapter according to the first communication data and the first internal resistance data.

A power tool includes: a tool body; an electric motor disposed in the tool body; a power interface capable of connecting to at least an adapter to supply power to the electric motor; and a control circuit configured to have multiple control modes to control the operation of the electric motor. The control circuit includes at least: a data acquisition module connected to at least the power interface to acquire first communication data and/or first internal resistance data sent by the adapter; and a controller configured to identify the adapter according to the first communication data and/or the first internal resistance data.

In some examples, the data acquisition module includes a second communication module configured to acquire the first communication data and/or the first internal resistance data in a wired communication manner and/or a wireless communication manner.

In some examples, the first communication data includes at least adapter identification data capable of distinguishing the adapter from a battery pack for the power tool.

In some examples, the first communication data includes an identification frame and a communication frame, where the adapter identification data is provided in the identification frame and/or the communication frame.

In some examples, the first communication data is acquired and then the first internal resistance data is acquired after a preset period so that the adapter is identified according to the first communication data and the first internal resistance data.

A power tool includes: a tool body; an electric motor disposed in the tool body; a power interface configured to be connected to a battery pack or an adapter; and a control circuit configured to have multiple control modes to control the operation of the electric motor. The control circuit includes at least: a data acquisition module connected to at least the power interface to acquire battery pack data transmitted by the battery pack or acquire adapter data transmitted by the adapter; and a controller configured to control the electric motor to operate in a first constant power mode when identifying, according to the battery pack data, that the power interface is connected to the battery pack and control the electric motor to operate in a second constant power mode when identifying, according to the adapter data, that the power interface is connected to the adapter. The output power in the first constant power mode is different from the output power in the second constant power mode.

In some examples, the battery pack data includes second communication data and/or second internal resistance data, and the adapter data includes first communication data and/or first internal resistance data.

In some examples, the controller is configured to control the output power of the electric motor to be less than the maximum allowable output power of the adapter when identifying, according to the first communication data and/or the first internal resistance data, that the power interface is connected to the adapter.

In some examples, the controller is configured to control the bus current of the control circuit to be less than or equal to a first current value when identifying, according to the first communication data and/or the first internal resistance data, that the power interface is connected to the adapter; and control the bus current of the control circuit to be less than or equal to a second current value when identifying, according to the second communication data and/or the second internal resistance data, that the power interface is connected to the battery pack; where the first current value is not equal to the second current value.

In some examples, the controller is configured to control a starting parameter for starting the electric motor when identifying, according to the first communication data and/or the first internal resistance data, that the power interface is connected to the adapter.

In some examples, the power tool further includes a battery level display device configured to display battery level information of a power supply connected to the power tool, where the controller is configured to control the battery level display device to be in a preset battery level state when identifying, according to the first communication data and/or the first internal resistance data, that the power interface is connected to the adapter.

A tool system includes: a power tool; and an adapter or a battery pack. The adapter includes at least a tool interface configured to be connected to a power interface of the power tool to output electrical energy; and a data transmission module connected to at least the tool interface and capable of outputting adapter data to the tool interface. The battery pack includes at least a battery pack interface configured to be connected to the power interface of the power tool to output electrical energy; and a battery management module connected to at least the battery pack interface and capable of outputting battery pack data to the tool interface. The power tool includes at least a tool body; an electric motor disposed in the tool body; a power interface configured to be connected to the battery pack or the adapter; and a control circuit configured to have multiple control modes to control the operation of the electric motor. The control circuit includes at least: a data acquisition module connected to at least the power interface to acquire the battery pack data transmitted by the battery pack or acquire the adapter data transmitted by the adapter; and a controller configured to identify the battery pack or the adapter according to the battery pack data or the adapter data.

### BRIEF DESCRIPTION OF THE DRAWINGS

FIG. 1 is a structural view of a power tool system according to an example of the present application.

FIG. 2 is a structural view of a power tool system according to an example of the present application.

FIG. 3 is a schematic diagram of a circuit structure of a power tool according to an example of the present application.

FIG. 4 is a schematic diagram of a circuit structure of an adapter according to an example of the present application.

FIG. 5 is a schematic diagram of frames of communication data according to an example of the present application.

### DETAILED DESCRIPTION

Before any examples of this application are explained in detail, it is to be understood that this application is not limited to its application to the structural details and the arrangement of components set forth in the following description or illustrated in the above drawings.

In this application, the terms “comprising”, “including”, “having” or any other variation thereof are intended to cover an inclusive inclusion such that a process, method, article or device comprising a series of elements includes not only those series of elements, but also other elements not expressly listed, or elements inherent in the process, method, article, or device. Without further limitations, an element defined by the phrase “comprising a . . . ” does not preclude the presence of additional identical elements in the process, method, article, or device comprising that element.

In this application, the term “and/or” is a kind of association relationship describing the relationship between associated objects, which means that there can be three kinds of relationships. For example, A and/or B can indicate that A exists alone, A and B exist simultaneously, and B exists alone. In addition, the character “/” in this application generally indicates that the contextual associated objects belong to an “and/or” relationship.

In this application, the terms “connection”, “combination”, “coupling” and “installation” may be direct connection, combination, coupling or installation, and may also be indirect connection, combination, coupling or installation. Among them, for example, direct connection means that two members or assemblies are connected together without intermediaries, and indirect connection means that two members or assemblies are respectively connected with at least one intermediate members and the two members or assemblies are connected by the at least one intermediate members. In addition, “connection” and “coupling” are not limited to physical or mechanical connections or couplings, and may include electrical connections or couplings.

In this application, it is to be understood by those skilled in the art that a relative term (such as “about”, “approximately”, and “substantially”) used in conjunction with quantity or condition includes a stated value and has a meaning dictated by the context. For example, the relative term includes at least a degree of error associated with the measurement of a particular value, a tolerance caused by manufacturing, assembly, and use associated with the particular value, and the like. Such relative term should also be considered as disclosing the range defined by the absolute values of the two endpoints. The relative term may refer to plus or minus of a certain percentage (such as 1%, 5%, 10%, or more) of an indicated value. A value that did not use the relative term should also be disclosed as a particular value with a tolerance. In addition, “substantially” when expressing a relative angular position relationship (for example, substantially parallel, substantially perpendicular), may refer to adding or subtracting a certain degree (such as 1 degree, 5 degrees, 10 degrees or more) to the indicated angle.

In this application, those skilled in the art will understand that a function performed by an assembly may be performed by one assembly, multiple assemblies, one member, or multiple members. Likewise, a function performed by a member may be performed by one member, an assembly, or a combination of members.

In this application, the terms “up”, “down”, “left”, “right”, “front”, and “rear” and other directional words are described based on the orientation or positional relationship shown in the drawings, and should not be understood as limitations to the examples of this application. In addition, in this context, it also needs to be understood that when it is mentioned that an element is connected “above” or “under” another element, it can not only be directly connected “above” or “under” the other element, but can also be indirectly connected “above” or “under” the other element through an intermediate element. It should also be understood that orientation words such as upper side, lower side, left side, right side, front side, and rear side do not only represent perfect orientations, but can also be understood as lateral orientations. For example, lower side may include directly below, bottom left, bottom right, front bottom, and rear bottom.

In this application, the terms “controller”, “processor”, “central processor”, “CPU” and “MCU” are interchangeable. Where a unit “controller”, “processor”, “central processing”, “CPU”, or “MCU” is used to perform a specific function, the specific function may be implemented by a single aforementioned unit or a plurality of the aforementioned unit.

In this application, the term “device”, “module” or “unit” may be implemented in the form of hardware or software to achieve specific functions.

In this application, the terms “computing”, “judging”, “controlling”, “determining”, “recognizing” and the like refer to the operations and processes of a computer system or similar electronic computing device (e.g., controller, processor, etc.).

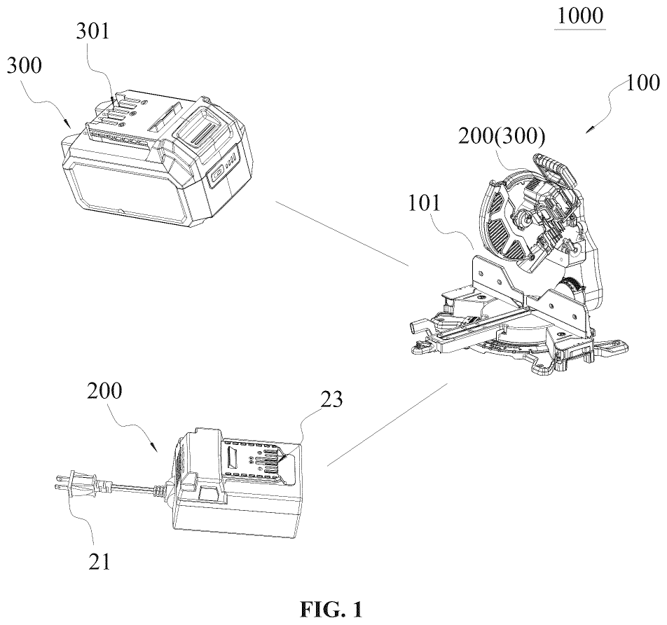

A power tool system 1000 shown in FIG. 1 may include a power tool 100, an adapter 200, or a battery pack 300. The power tool 100 may be connected to the battery pack 300 and powered by the battery pack 300, or the power tool 100 may be connected to the adapter 200 and powered through the adapter 200. It is to be understood that one end of the adapter 200 may be connected to AC mains power or a solar panel, the other end of the adapter 200 may be connected to the power tool 100, and the adapter 200 can perform at least AC-DC conversion on the electrical energy so that the power tool 100 can be powered. In this example, the interface type of one end of the adapter 200 connected to the power tool 100 may be at least partially consistent with the type of the interface through which the battery pack 300 is connected to the power tool 100. In FIG. 1, a power supply device connected to the power tool 100 may be the adapter 200 or the battery pack 300. The battery pack 300 may be connected to the power tool 100 through a battery pack interface 301, and the adapter 200 may be connected to the power tool 100 through a tool interface 23.

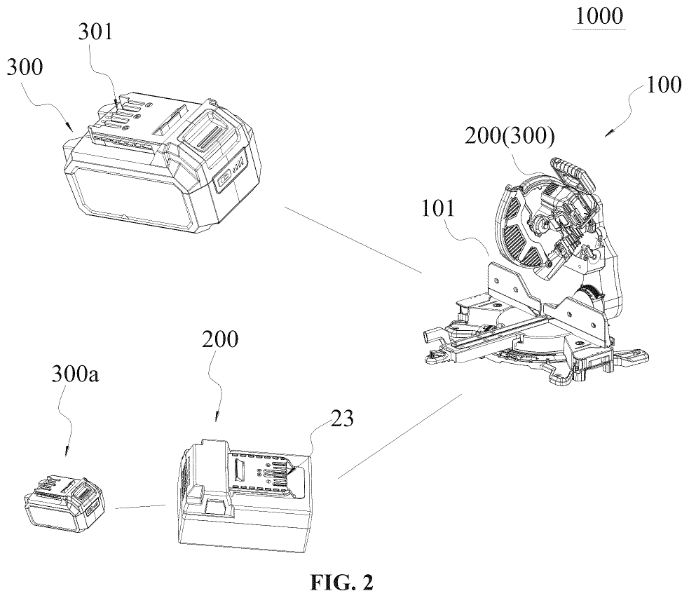

In an example, as shown in FIG. 2, one end of the adapter 200 may be connected to a battery pack 300a, the other end of the adapter 200 may be connected to the power tool 100, and the adapter 200 can perform DC-DC conversion on the electrical energy and output the electrical energy that can power the power tool 100. Alternatively, in an optional example, one end of the adapter 200 may be connected to the battery pack 300a, the other end of the adapter 200 may be connected to an AC power tool, and the adapter 200 can perform DC-AC conversion on the electrical energy and output the electrical energy that can power the AC power tool.

In this example, the power tool 100 may be a handheld power tool, such as a drill, a hedge trimmer, or a sander. Alternatively, the power tool 100 may be a table tool, such as a table saw or a miter saw. Alternatively, the power tool 100 may be a push power tool, such as a push mower or a push snow thrower. Alternatively, the power tool 100 may be a riding power tool, such as a riding mower, a riding vehicle, or an all-terrain vehicle. Alternatively, the power tool 100 may be a robotic tool, such as a robotic mower or a robotic snow thrower. In some examples, the power tool 100 may be an electric drill, an electric lamp, an electric vehicle, or the like. In some examples, the power tool 100 may be a garden tool, such as a hedge trimmer, a blower, a mower, or a chainsaw. Alternatively, the power tool 100 may be a decorating tool, such as a screwdriver, a nail gun, a circular saw, or a sander. In some examples, the power tool 100 may be a vegetation care tool, such as a string trimmer, a mower, a hedge trimmer, or a chainsaw. Alternatively, the power tool 100 may be a cleaning tool, such as a blower, a snow thrower, or a cleaning machine. Alternatively, the power tool 100 may be a drilling tool, such as a drill, a screwdriver, a wrench, or an electric hammer. Alternatively, the power tool 100 may be a sawing tool such as a reciprocating saw, a jigsaw, or a circular saw. Alternatively, the power tool 100 may be a table tool, such as a table saw, a miter saw, a metal cutter, or an electric router. Alternatively, the power tool 100 may be a sanding tool, such as an angle grinder or a sander. Alternatively, the power tool 100 may be another tool, such as a lamp or a fan.

In the present application, a table saw 100 shown in FIGS. 1 and 2 is used as an example for description. The table saw 100 includes at least a tool body 101, an electric motor 102 disposed in the tool body 101, a power interface 103, and a control circuit 104 disposed in the tool body 101. In this example, the electric motor 102 may be a brushed electric motor or a brushless electric motor. The power interface 103 can be connected to the adapter 200 or the battery pack 300. The power interface 103 may be a USB type interface, such as a USB-A type interface or a USB-C type interface, or the power interface 103 may be an interface with metal connection pieces, such as a positive connection piece, a negative connection piece, and a communication connection piece. The present application does not limit the type of the power interface 103.

In this example, since the adapter 200 and the battery pack 300 have different working characteristics or characteristic parameters, when the adapter 200 and the battery pack 300 separately supply power to the power tool 100, the working modes or working characteristics of the power tool 100 may be different. For example, when the power tool 100 is separately powered by the adapter 200 and the battery pack 300, the electric motor 102 may have different operating currents when started, or the starting manners may be different, or the braking manners of the electric motor 102 may be different. For example, if the power tool 100 is powered by the battery pack 300, a reverse charging current may exist in the control circuit 104 when the electric motor 102 brakes, thereby reversely charging the battery pack 300. If the power tool 100 is powered by the adapter 200, a reverse charging current cannot exist in the control circuit 104 when the electric motor 102 brakes. Therefore, when the power tool 100 is powered by the battery pack 300, a controller 12 may control the electric motor 102 to brake in an energy recovery mode. When the power tool 100 is powered by the adapter 200, the controller 12 may control the electric motor 102 to brake via short-circuit braking or inertia-based braking.

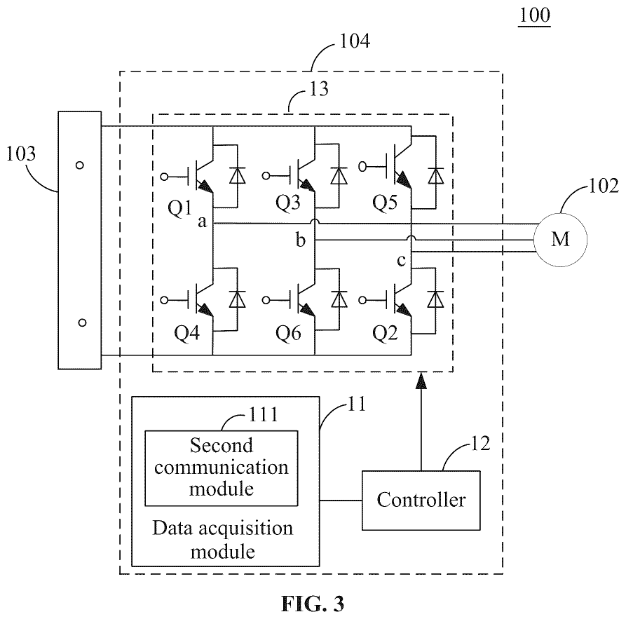

As shown in FIG. 3, the control circuit 104 may include at least a data acquisition module 11, a controller 12, and a driver circuit 13. The data acquisition module 11 can be connected to the power interface 103 to acquire data from the power interface 103. The controller 12 is connected to the data acquisition module 11 and can identify whether the power supply device connected to the power tool 100 is the adapter 200 or the battery pack 300 based on the obtained data, thereby controlling the electric motor 102 to operate in different working modes according to the different power supply devices connected to the power tool 100. The different control strategies adopted by the controller 12 according to the different power supply devices connected to the power tool 100 are described in detail in the examples below. The driver circuit 13 is electrically connected to the stator windings of the electric motor 102 and configured to transmit the current from the power supply device (the battery pack 300 or the adapter 200) to the stator windings to drive the electric motor 102 to rotate. In an example, the driver circuit 13 includes multiple switching elements Q1, Q2, Q3, Q4, Q5, and Q6. A gate terminal of each switching element is electrically connected to the controller 12 and used for receiving the control signal from the controller 12, where the control signal may be a pulse-width modulation (PWM) signal. The drain or source of each switching element is connected to the stator winding of the electric motor 102. The switching elements Q1 to Q6 receive control signals from the controller 12 to change their respective on states, thereby changing the current loaded to the stator windings of the electric motor 102 by the power supply device. In an example, the driver circuit 13 may be a three-phase bridge driver circuit including six controllable semiconductor power devices (such as field-effect transistors (FETs), bipolar junction transistors (BJTs), or insulated-gate bipolar transistors (IGBTs)). It is to be understood that the preceding switching elements may be any other types of solid-state switches, such as IGBTs or BJTs.

As shown in FIG. 3, to drive the electric motor 102 to rotate, the driver circuit 13 has multiple driving states, and in different driving states, the electric motor 102 may have different rotational speeds or different rotational directions. In the present application, the process is not described in detail in which the controller 12 controls the driver circuit 13 to change different driving states such that the electric motor 102 has different rotational speeds or different directions of rotation.

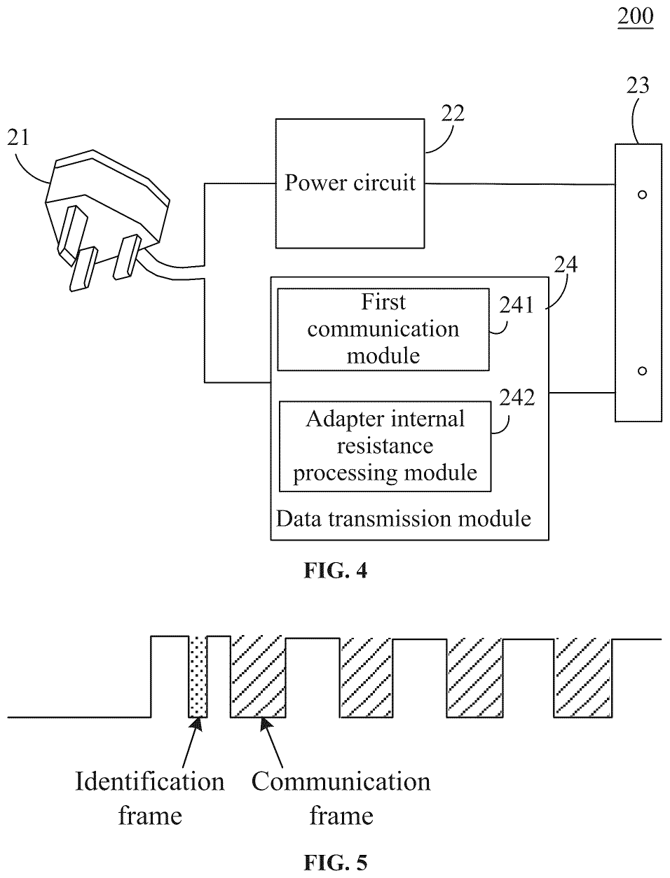

As shown in FIGS. 1 and 4, the adapter 200 includes at least an electrical energy input terminal 21, a power circuit 22, and a tool interface 23. The electrical energy input terminal 21 may be connected to AC mains power or a photovoltaic panel. The power circuit 22 can convert the inputted AC power into the electrical energy that can power the power tool 100. The tool interface 23 can be connected to at least the power interface 103 of the power tool 100 to transmit electrical energy.

In this example, the adapter 200 further includes a data transmission module 24, and the module is connected to at least the tool interface 23, can transmit at least the adapter data of the adapter 200, that is, the first communication data and/or the first internal resistance data to the tool interface 23, and can transmit the adapter data to the power interface 103 through the tool interface 23. The data acquisition module 11 on the power tool 100 can acquire the adapter data transmitted by the data transmission module 24, and then the controller 12 can identify the adapter 200 according to the adapter data. In an example, an electrical connection port and a communication connection port are provided between the tool interface 23 and the power interface 103 to achieve the electrical connection and communication connection; and the data transmission module 24 can transmit communication data to the data acquisition module 11 through the communication connection channel between the tool interface 23 and the power interface 103. In an example, the first communication data and/or the first internal resistance data may be transmitted between the data transmission module 24 and the data acquisition module 11 in a wireless communication manner. For example, the data transmission module 24 may transmit the first communication data and/or the first internal resistance data to the data acquisition module 11 via Bluetooth, the wireless local area network, near-field communication, the cellular network, Zigbee, or the like.

In this example, the first communication data may include at least adapter identification data capable of distinguishing the adapter 200 from the battery pack 300, such as the model and product parameters of the adapter 200. In this example, a resistor that can identify the adapter type may be provided in the adapter 200, and the parameter information of the resistor, that is, the first internal resistance data, may be transmitted to the power tool 100 through the data transmission module 24. That is to say, the first communication data or the first internal resistance data can uniquely identify the identity of the adapter 200.

As shown in FIG. 4, the data transmission module 24 includes at least a first communication module 241, and the first communication module 241 is configured to transmit the first communication data and/or the first internal resistance data in a wired communication manner and/or a wireless communication manner. The wired communication manner may include carrier communication, communication line communication, connection piece communication, or the like. For example, the tool interface 23 includes a positive electrode interface, a negative electrode interface, and a communication interface, and the communication interface may be configured to be a communication connection piece that can be communicatively connected to the communication connection piece in the power interface 103 to transmit the adapter data. The wireless communication manner may include one or more common wireless communication technologies, such as Bluetooth, the wireless local area network, near-field communication, the cellular network, or Zigbee. In this example, the first communication module 241 supports at least a communication protocol the same as that of the battery pack 300. For example, the first communication module 241 supports the Bluetooth communication protocol, and the battery pack 300 also supports the Bluetooth communication protocol.

Correspondingly, referring to FIG. 3, the data acquisition module 11 in the power tool 100 may include a second communication module 111 that is communicatively connected to at least the first communication module 241 and can acquire the first communication data and/or the first internal resistance data transmitted by the first communication module 241. In this example, the first communication module 241 and the second communication module 111 support at least one same communication protocol.

In an example, the data transmission module 24 further includes an adapter internal resistance processing module 242, and the module can collect at least the resistance information of a resistor that identifies the adapter type and can transmit the resistance information to the power tool 100 through the first communication module 241.

As shown in FIG. 5, the first communication data may include an identification frame and a communication frame, and the identification frame and the communication frame may have different transmission frequencies or transmission protocols so that the data acquisition module 11 on the power tool 100 can identify the adapter 200 according to the transmission frequency or transmission protocol of the frame. In an example, the adapter identification data may be provided in the identification frame or the communication frame, or the adapter identification data may be provided in both the identification frame and the communication frame. That is to say, the data acquisition module 11 on the power tool 100 may identify the adapter 200 according to the adapter identification data in the identification frame or the communication frame. In an example, the identification frame and the communication frame have different transmission frequencies or different transmission protocols, the identification frame carries at least the adapter identification data, and the communication frame may include the working parameter of the adapter 200 in normal operation, such as the operating voltage, current, temperature, or output power of the adapter 200. That is to say, the power tool 100 can identify the adapter 200 through the identification frame sent by the adapter 200 and acquire the working parameter of the adapter 200 in normal operation through the communication frame sent by the adapter 200. In an example, the identification frame and/or the communication frame may be square wave signals or coded signals composed of binary digits.

In this example, after the connection between the adapter 200 and the power tool 100 is established, the first communication module 241 may first send the identification frame to the data acquisition module 11 and then send the communication frame after a certain period. Therefore, the power tool 100 can first identify the identity of the adapter 200 through the identification frame and after determining the identity of the adapter 200, continue to acquire the working parameter of the adapter 200. In an optional example, the communication frame sent by the first communication module 241 may carry the adapter identification data in addition to normal working parameters so that the power tool 100 can determine the identity of the adapter 200 each time the power tool 100 receives the working parameters of the adapter 200. In an optional example, the communication frames sent by the first communication module 241 carry the adapter identification data at intervals of a certain frame length.

In an example, the data transmission module 24 may first output the first communication data to the tool interface 23 or output the first communication data to the data acquisition module 11 in a wireless communication manner, and after a preset period, the data transmission module 24 may transmit the first internal resistance data to the tool interface 23 or output the first internal resistance data to the data acquisition module 11 in a wireless communication manner. Therefore, the controller 12 on the power tool 100 can first identify the adapter according to the first communication data and then identify the adapter again according to the first internal resistance data. Through double identification and double determination, it is ensured that the power tool 100 can accurately identify the adapter. In an example, the data transmission module 24 may first send the first internal resistance data and then send the first communication data after a preset period. It is to be understood that the time intervals at which the data transmission module 24 sends the first communication data and the first internal resistance data may be different for different types of adapters, which is not specifically limited here.

In this example, the battery pack 300 also has a data transmission module (not shown) that can perform wired or wireless communication with the data acquisition module 11 on the power tool 100, and the data transmission module in the battery pack 300 and the data transmission module 24 in the adapter 200 may have the same data transmission manner, for example, the same wired transmission manner or the same wireless transmission manner. In this example, the data transmission module in the battery pack 300 can transmit the battery pack data, that is, the second communication data and/or the second internal resistance data, to the power tool 100. The data acquisition module 11 on the power tool 100 can acquire the battery pack data transmitted by the data transmission module in the battery pack 300, and then the controller 12 can identify the battery pack 300 according to the battery pack data. In this example, the connection manner in which the battery pack 300 is connected to the power tool 100 may be consistent or partially consistent with the connection manner in which the adapter 200 is connected to the power tool 100, and the details are not repeated here. For the second communication data and/or the second internal resistance data outputted by the battery pack 300, reference may be made to the first communication data and/or the first internal resistance data outputted by the adapter 200. For example, the second communication data may include at least battery pack identification data capable of distinguishing the battery pack 300 from the adapter 200, such as the model and product parameters of the battery pack 300. Alternatively, the second communication data may include an identification frame and a communication frame. For the identification frame and the communication frame here, reference may be made to the settings of the identification frame and the communication frame outputted by the adapter 200, such as the frame transmission frequency, the frame transmission protocol, or the information contained in the frame data.

In this example, the data acquisition module 11 in the power tool 100 may be configured to stop acquiring identification frames or stop receiving the adapter data or battery pack data if no identification frames are acquired within a certain period. In this case, the controller 12 may determine that a connection failure exists between the adapter 200 or the battery pack 300 and the power tool 100.

In an example, when the power tool 100 identifies that the power supply device connected to the power interface 103 is the battery pack 300, the working modes of the power tool 100 may be some working modes well known to those skilled in the art and are not listed here one by one.

In some examples, the battery packs connected to the power tool 100 have different models or battery levels, and the corresponding state of power (SOP) parameters representing the maximum allowable output power of the battery packs are also set differently. For example, the SOP values of battery packs with different signals at different battery levels are shown in Table 1.

TABLE 1

| | | | SOP settings at different battery levels | | | | | | | | | | |
|---|---|---|---|---|---|---|---|---|---|---|---|---|---|
| Capacity | | Model | 100% | 90% | 80% | 70% | 60% | 50% | 40% | 30% | 20% | 10% | 5% |
| 2.5 | Ah | 8715 | 55 | 55 | 55 | 55 | 55 | 55 | 55 | 55 | 55 | 20 | 20 |
| 5 | Ah | 8716 | 110 | 110 | 110 | 110 | 110 | 110 | 110 | 110 | 110 | 40 | 40 |
| 3.5 | Ah | 8727 | 140 | 140 | 140 | 140 | 130 | 130 | 130 | 120 | 120 | 120 | 120 |
| 8 | Ah | 8718 | 160 | 160 | 142 | 132 | 124 | 114 | 106 | 96 | 88 | 60 | 60 |
| 12 | Ah | 8717 | 180 | 180 | 180 | 180 | 180 | 171 | 159 | 144 | 132 | 90 | 90 |
| 6 | Ah | 8726 | 200 | 200 | 200 | 200 | 180 | 180 | 180 | 150 | 150 | 120 | 75 |
| 10 | Ah | 8719 | 200 | 200 | 200 | 200 | 200 | 200 | 200 | 200 | 200 | 130 | 90 |

In some examples, when the power tool 100 identifies that the connected power supply device is the battery pack 300, the controller 12 may control the bus current of the operating electric motor 102 to not exceed a second current threshold, for example, not exceed 300 A.

In some examples, when the power tool 100 identifies that the connected power supply device is the battery pack 300, the starting parameter of the electric motor 102 may be controlled according to the electrical parameter of the battery pack 300. For example, the width of the positioning pulse for starting the electric motor 102 may be controlled according to the real-time voltage or internal resistance of the battery pack 300. For example, before the electric motor is started, different pulse widths are set according to the voltage and/or internal resistance information of the battery pack 300 to ensure that the pulse current is not too large or too small and the electric motor can be accurately positioned. When the voltage of the battery pack 300 is small, the pulse width is increased; when the voltage of the battery pack 300 is large, the pulse width is reduced; when the internal resistance of the battery pack 300 is small, the pulse width is reduced; and when the internal resistance of the battery pack 300 is large, the pulse width is increased. In this example, the positioning pulse may be understood as a pulse for determining the rotor position for the next commutation in an inductance method when the electric motor is not started to ensure that the electric motor can be started normally.

In this example, when the power tool 100 identifies that the connected power supply device is the battery pack 300, the electric motor 102 may be controlled to operate in a first constant power mode; and when the power tool 100 identifies that the connected power supply device is the adapter 200, the electric motor 102 may be controlled to operate in a second constant power mode. The output power in the first constant power mode is different from the output power in the second constant power mode. That is to say, although the power tool 100 can operate at constant power no matter when the power tool 100 is connected to the battery pack 300 or the adapter 200, the output power is different. In an example, the output power of the electric motor in the first constant power mode is the same as the output power of the electric motor in the second constant power mode.

In an example, when the power tool 100 identifies that the connected power supply device is the battery pack 300, the electric motor 102 may be controlled to operate in a first constant current mode; and when the power tool 100 identifies that the connected power supply device is the adapter 200, the electric motor 102 may be controlled to operate in a second constant current mode. The output current in the first constant current mode is different from the output current in the second constant current mode.

In an example, when the power tool 100 identifies that the power supply device connected to the power interface 103 is the adapter 200, the controller 12 is configured to at least respond to a braking signal and control the electric motor 102 to not generate a reverse charging current during braking.

In an example, when the power tool 100 identifies that the power supply device connected to the power interface 103 is the adapter 200, the controller 12 is configured to control the bus current of the operating electric motor 102 to not exceed a first current threshold, for example, not exceed 200 A. In this example, the first current threshold is less than the second current threshold. In an example, the first current threshold is the same as the second current threshold.

In an example, when the power tool 100 identifies that the power supply device connected to the power interface 103 is the adapter 200, the controller 12 is configured to control the width of the positioning pulse for starting the electric motor 102 to be 120 μs.

In an example, the power tool 100 may further include a battery level display device 105 capable of displaying the battery level information of the power supply device connected to the power tool 100. For example, the battery level display device 105 may display the remaining power of the power supply device or may issue an alarm prompt by changing the display state when the voltage or battery level of the power supply device is too low. In this example, when the power tool 100 identifies that the power supply device connected to the power interface 103 is the adapter 200, the controller 12 is configured to control the battery level display device 105 to be in a preset battery level state. In the preset battery level state, at least a fully charged state may be continuously displayed, or a state of a constant battery level value may be continuously displayed.

The basic principles, main features, and advantages of this application are shown and described above. It is to be understood by those skilled in the art that the aforementioned examples do not limit the present application in any form, and all technical solutions obtained through equivalent substitutions or equivalent transformations fall within the scope of the present application.

What is claimed is:

1. An adapter, comprising:
a power input terminal that connects an alternating current (AC) power supply;
a power circuit that performs energy conversion on inputted AC power to obtain electrical energy to power a power tool;
a tool interface that connects to a power interface of the power tool and outputs electrical energy; and
a data transmission module that connects to at least the tool interface and outputs first communication data and/or first internal resistance data to the tool interface so that the power tool is capable of identifying the adapter according to the first communication data and/or the first internal resistance data;
wherein the first communication data comprises at least adapter identification data, and the adapter identification data enables the power tool to identify that a connected device is the adapter between the adapter and a battery pack.

2. The adapter of claim 1, wherein the data transmission module comprises a first communication module, and a communication protocol supported by the first communication module is at least the same as a communication protocol supported by the battery pack.

3. The adapter of claim 1, wherein a first communication module transmits the first communication data and/or the first internal resistance data in a wired communication manner and/or a wireless communication manner.

4. The adapter of claim 1, wherein the first communication data comprises an identification frame and a communication frame, and the adapter identification data is provided in the identification frame and/or the communication frame.

5. The adapter of claim 1, wherein the data transmission module comprises an adapter internal resistance processing module capable of at least detecting and transmitting the first internal resistance data.

6. The adapter of claim 1, wherein the data transmission module outputs the first communication data and then transmits the first internal resistance data after a preset period so that the power tool is capable of identifying the adapter according to the first communication data and the first internal resistance data.

7. The adapter of claim 1, wherein the data transmission module transmits the first communication data and/or the first internal resistance data via at least one of Bluetooth, a wireless local area network, near-field communication, a cellular network, and Zigbee.

8. A power tool, comprising:
a tool body;
an electric motor disposed in the tool body;
a power interface that connects to at least an adapter to supply power to the electric motor; and
a control circuit having a plurality of control modes to control operation of the electric motor, the control circuit comprising a data acquisition module connected to at least the power interface to acquire first communication data and/or first internal resistance data sent by the adapter, and a controller that identifies the adapter according to the first communication data and/or the first internal resistance data.

9. The power tool of claim 8, wherein the data acquisition module comprises a second communication module that acquires the first communication data and/or the first internal resistance data in a wired communication manner and/or a wireless communication manner.

10. The power tool of claim 8, wherein the first communication data comprises at least adapter identification data capable of distinguishing the adapter from a battery pack for the power tool.

11. The power tool of claim 10, wherein the first communication data comprises an identification frame and a communication frame, and the adapter identification data is provided in the identification frame and/or the communication frame.

12. The power tool of claim 8, wherein the controller acquires the first communication data and then acquires the first internal resistance data after a preset period to identify the adapter according to the first communication data and the first internal resistance data.

13. The power tool of claim 9, wherein the second communication module acquires the first communication data and/or the first internal resistance data via at least one of Bluetooth, a wireless local area network, near-field communication, a cellular network, and Zigbee.

14. A power tool, comprising:
a tool body;
an electric motor disposed in the tool body;
a power interface that connects to a battery pack or an adapter; and
a control circuit having a plurality of control modes to control operation of the electric motor, the control circuit comprising a data acquisition module connected to at least the power interface to acquire battery pack data transmitted by the battery pack or acquire adapter data transmitted by the adapter, and a controller that controls the electric motor to operate in a first constant power mode when the controller identifies, according to the battery pack data, that the power interface is connected to the battery pack and controls the electric motor to operate in a second constant power mode when the controller identifies, according to the adapter data, that the power interface is connected to the adapter;
wherein output power in the first constant power mode is different from output power in the second constant power mode.

15. The power tool of claim 14, wherein the battery pack data comprises second communication data and/or second internal resistance data, and the adapter data comprises first communication data and/or first internal resistance data.

16. The power tool of claim 15, wherein the controller controls output power of the electric motor to be less than a maximum allowable output power of the adapter when the controller identifies, according to the first communication data and/or the first internal resistance data, that the power interface is connected to the adapter.

17. The power tool of claim 15, wherein the controller controls a bus current of the control circuit to be less than or equal to a first current value when the controller identifies, according to the first communication data and/or the first internal resistance data, that the power interface is connected to the adapter; and controls a bus current of the control circuit to be less than or equal to a second current value when the controller identifies, according to the second communication data and/or the second internal resistance data, that the power interface is connected to the battery pack; and the first current value is not equal to the second current value.

18. The power tool of claim 15, wherein the controller controls a starting parameter for starting the electric motor when the controller identifies, according to the first communication data and/or the first internal resistance data, that the power interface is connected to the adapter.

19. The power tool of claim 15, further comprising a battery level display device that displays battery level information of a power supply connected to the power tool, wherein the controller controls the battery level display device to be in a preset battery level state when the controller identifies, according to the first communication data and/or the first internal resistance data, that the power interface is connected to the adapter.

20. The power tool of claim 14, wherein the data acquisition module acquires first communication data and/or first internal resistance data via at least one of Bluetooth, a wireless local area network, near-field communication, a cellular network, and Zigbee.
